(19) United States
(12) Patent Application Publication
(10) Pub. No.: US 2009/0211641 A1
(43) Pub. Date: Aug. 27, 2009

(54) DISTRIBUTION VALVE AND METHOD

(76) Inventor: Donald Tipotsch, Tempe, AZ (US)

Correspondence Address: WEISS & MOY PC, 4204 NORTH BROWN AVENUE, SCOTTSDALE, AZ, 85251, US

(21) Appl. No.: 12/035,200

(22) Filed: Feb. 21, 2008

(51) Int. Cl. F16K 31/52; F16K 11/06

(52) U.S. Cl. 137/1; 137/625.11; 137/627

(57) ABSTRACT

An improved distribution valve is provided that distributes water from a swimming pool pump to cleaning heads located along the inner surface of a swimming pool. The distribution valve includes a housing having a fluid inlet and a plurality of fluid outlet ports. The housing includes a lower section and a removable upper section. A gear reduction assembly located in the housing includes a gear reduction mechanism and impeller located near the inlet port and connected to a rotary input shaft of the gear reduction mechanism. A cam device engages a rotary output shaft of the gear reduction mechanism so as to rotate the cam device in response to rotation of the impeller. The cam device rotates under a pliable annular disc on the rotary output shaft and lifts and lowers portions of the annular disc to sequentially open and close fluid paths through the fluid outlet ports.

The improved distribution valve may include a bypass chamber with a rotatable drum therein and a diffusion chamber in fluid communication with the fluid inlet. The drum wall includes a cutout. The drum is rotatable to fully or partially align the cutout with a bypass chamber inlet to permit water flow through the bypass chamber to help rotate the impeller. The impeller speed may be controlled by adjusting the water flow through the bypass chamber. The more water flow, the faster the impeller rotates. The drum is also rotatable to block the bypass chamber inlet to prevent water flow through the bypass chamber, in which case water from the diffusion chamber rotates the impeller. Impeller rotation will be at a slower speed due to the decreased water flow.

### FIELD OF THE INVENTION

This invention relates generally to distribution valves for distributing water from a swimming pool pump to cleaning heads located along the inner surface of a swimming pool. More specifically, this invention relates to an improved distribution valve that optimizes water flow to outlet ports without using complicated valve assemblies while minimizing stress and tension on the gear assembly while substantially eliminating leaking.

### BACKGROUND OF THE INVENTION

Distribution valves receive water from the high-pressure side of a swimming pool pump through an inlet port and distribute the water under high pressure through sequential outlet ports to various groups of cleaning heads located along the inner surface of a swimming pool.

A number of multi-port distribution valves are known. These include the distribution valves described in U.S. Pat. Nos. 4,523,606 and 4,570,663 commonly assigned to Shasta Industries, Inc. Each of the distribution valves disclosed in these patents includes an impeller driven gear reduction mechanism and a plurality of outlet valves controlled in response to the gear reduction mechanism. The gear reduction mechanism includes a stationary planetary gear disposed about a vertical axis of the distribution valve, a pair of symmetric gear assemblies each driven by a gear attached to an impeller, with each of the symmetric gear assemblies being supported on a rotary gear support base, and each also having an outer gear engaging the teeth of the planetary gear to cause the rotary gear assembly base to rotate in response to rotation of the impeller and thereby drive at least one cam device which rotates through a 360 degree angle and sequentially displaces spherical acrylic balls from a valve seat of an outlet port. The outlet ports typically have an inclined upper peripheral edge surface that mates with the acrylic valve balls with vertical dividers between the outlet ports. A typical distribution valve has five or six outlet ports. Unfortunately, a fairly large force is required to be applied by the gear reduction mechanism to rotate the cam device that pushes the valve balls away from their valve seats in order to open the valves. Mineral deposits may occur on the valve balls and gears to further increase the amount of torque required to be applied by the cam device to push the valve balls from their valve seats. The increased amount of required torque greatly increases the amount of stress on the gears of the planetary gear assembly resulting in “locking up” of the gear reduction mechanism and the breaking of the gears in the planetary gear assembly. This results in increased repair and maintenance and downtime for the pool system. In addition the spherical acrylic valve balls often get debris embedded in them which then abrades the cam device when it rotates as well as abrading the distribution valve housing.

In U.S. Pat. No. 6,539,967, also assigned to Shasta Industries, Inc., the spherical acrylic balls were replaced by a retrofittable valve assembly. The valve assembly there included a valve seat in each fluid outlet port and a hinged valve plate connected to contact the valve seat so as to close the outlet port and to move away from the valve plate to open the outlet port. Each valve assembly also included a lift pin connected to the valve plate for engaging the cam device camming surface to open and close the outlet port as the cam device rotates. The retrofitting of existing distribution valves with the valve assembly described in U.S. Pat. No. 6,539,967 requires a large number of parts, subassemblies and sometimes the application of glue. The distribution valves described in the above-referenced patents also require disassembly to adjust the rotational speed of the impeller.

Accordingly, there has been a need for a novel distribution valve which is of simplified construction, inexpensive to manufacture and optimizes water flow to the pool cleaning heads. There is a still further need for a distribution valve that substantially minimizes stress and wear on the gear assembly, the cam device and the housing to maintain the efficiency and longevity of the distribution valve and to reduce maintenance and repair costs and downtime. There is an additional need for a distribution valve that substantially eliminates the use of subassemblies, numerous parts and glue. There is a further need for a distribution valve in which the rotational speed of the impeller may easily be adjusted without disassembly of the distribution valve. The present invention fulfills these needs and provides other related advantages.

### SUMMARY OF THE INVENTION

It is an object of the invention to provide an improved distribution valve with a longer life gear reduction assembly, cam device and housing which substantially reduces maintenance and repair costs and downtime.

It is another object of the invention to provide an improved distribution valve which optimizes water flow to the pool cleaning heads without the use of complicated valve and sub-assemblies, parts and glue.

It is still another object of the invention to provide an improved distribution valve which permits controlling the speed of the impeller to deliver more or less water to the pool cleaning heads.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of an upper housing section embodying the invention, illustrating a speed control assembly at the top of the upper housing section with a fluid inlet port between a diffusion chamber and a bypass chamber;

FIG. 2 is a top view of the upper housing section of FIG. 1;

FIG. 3 is another perspective view of the upper housing section of FIGS. 1 and 2, illustrating water flow from the fluid inlet port through a bypass chamber inlet into the bypass chamber and through a diffusion chamber inlet into the diffusion chamber and discharged therefrom through respective bypass chamber and diffusion chamber outlets;

FIG. 4 is a partial cutaway view of the upper housing section of FIGS. 1-3, illustrating a drum within the bypass chamber having a cutout in a wall therein with the drum rotated to block the bypass chamber inlet to prevent water flow into the bypass chamber so that water flows from the fluid inlet port into only the diffusion chamber from where it is then discharged into the lower housing section (not shown);

FIG. 5 is another partial cutaway view of the upper housing section, illustrating the drum cutout aligned with the bypass chamber inlet to permit water flow into the bypass chamber (along with water flow into the diffusion chamber);

FIG. 6 is a cutaway view of the bypass chamber of the speed control assembly, illustrating the drum within the bypass chamber and the drum rotated to block the bypass chamber inlet with the encircled region an exploded views of the bypass chamber tab engaged in the drum slot at a distal end thereof;

FIG. 6A is another cutaway view of the bypass chamber similar to FIG. 6, illustrating the drum rotated to align the drum cutout with the bypass chamber inlet with the exploded view of the bypass chamber tab engaged in the slot at a proximal end thereof;

FIG. 7 is a perspective assembly view of one embodiment of an improved distribution valve embodying the invention, illustrating an upper housing section having a speed control assembly and the manner in which a substantially pliable annular disc is positioned within a lower housing section of the distribution valve over a plurality of fluid outlet ports and a portion of a cam device to form a “lower housing valve assembly” with the prior art gear reduction assembly shown in dotted lines;

FIG. 8 is a perspective view of a lower housing valve assembly and a vertical axle from a prior art gear reduction mechanism, illustrating the annular disc positioned and supported in the bottom of the lower housing section over the plurality of outlet ports (shown in dotted lines) and with a portion thereof lifted over the cam device (shown by irregular lines), the encircled region an exploded view of support ribs extending across the plurality of outlet ports;

FIG. 9 is a sectional view of the lower housing valve assembly and drive of FIG. 7;

FIG. 10 is another sectional view similar to FIG. 9, illustrating by arrows water flow under the annular disc to the bottom of the lower housing section, through the front end of the cam device and a substantially U-shaped opening and into a cam device channel, and out through one of the fluid outlet ports;

FIG. 11 is an enlarged partial sectional view of the lower housing section of the distribution valve of FIG. 7, illustrating a pair of shims under an eccentric rotation point of the cam device;

FIG. 12 is an elevational view of a leading rising side of the cam device;

FIG. 13 is another elevational view of an opposite trailing falling side of the cam device;

FIG. 14 is a front closed end view of the cam device;

FIG. 15 is a rear open end view of the cam device, illustrating the substantially U-shaped cam device channel;

FIG. 16 is an elevational rear view of the cam device; and

FIG. 17 is a bottom view of the cam device.

### DETAILED DESCRIPTION OF THE INVENTION

As shown in the drawings for purposes of illustration, the present invention is concerned with an improved distribution valve, generally designated in the accompanying drawings by the reference number 10. The improved distribution valve 10 comprises, generally, an upper housing section 12, a gear reduction assembly 14 inside the upper housing section 12, the gear reduction assembly 14 including a gear reduction mechanism 16 and an impeller 18 located in fluid communication with a fluid inlet port 20 and connected to a rotary input shaft 22 to drive the gear reduction mechanism 16, a lower housing valve assembly 24 adapted for sealing engagement with the upper housing section 12 and comprised of a lower housing section 26 having a plurality of fluid outlet ports 28, a substantially pliable annular disc 30 that overlies the plurality of fluid outlet ports 28 and disposed on a rotary output shaft 32 of the gear reduction mechanism 16, and a cam device 34 engaging the rotary output shaft 32 and rotating under the substantially pliable annular disc 30 in response to rotation of the impeller 18 to lift and lower portions of the annular disc 30 to sequentially open and close fluid paths through the plurality of fluid outlet ports 28. The improved distribution valve 10 may further comprise a speed control assembly 36 for controlling the rotation speed of the impeller 18.

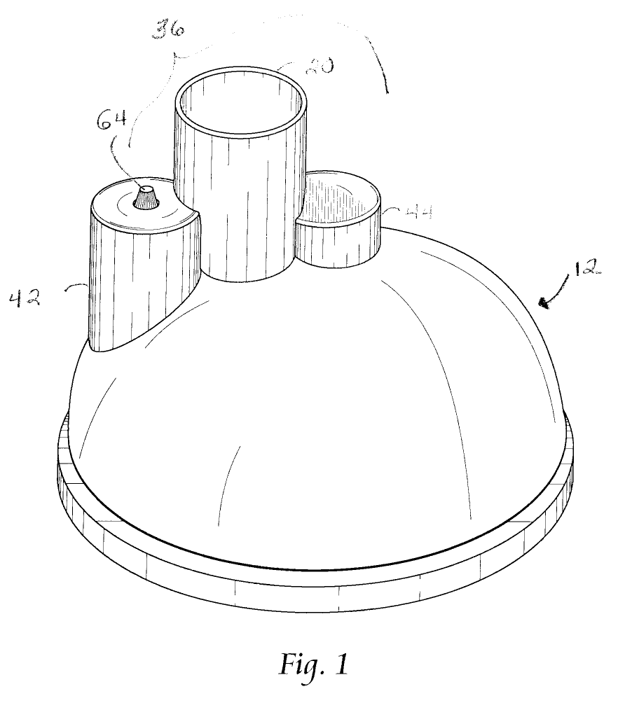

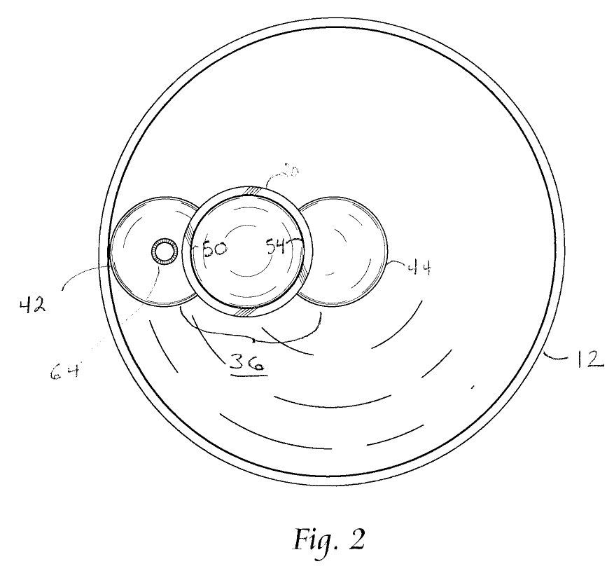

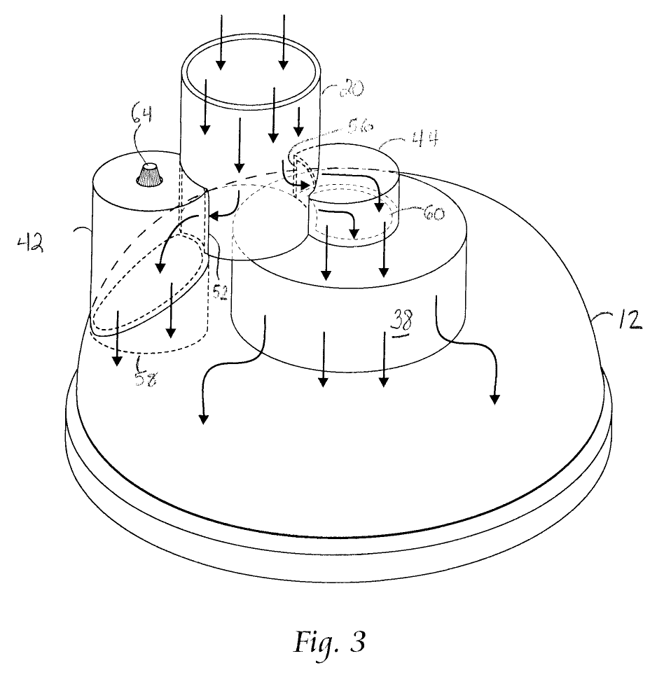

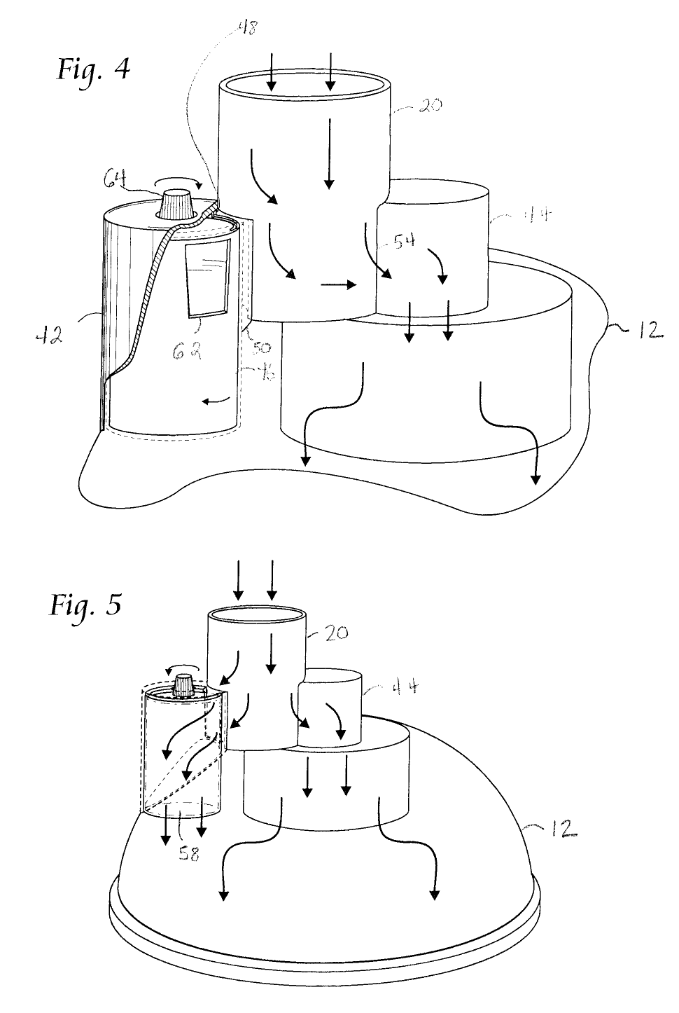

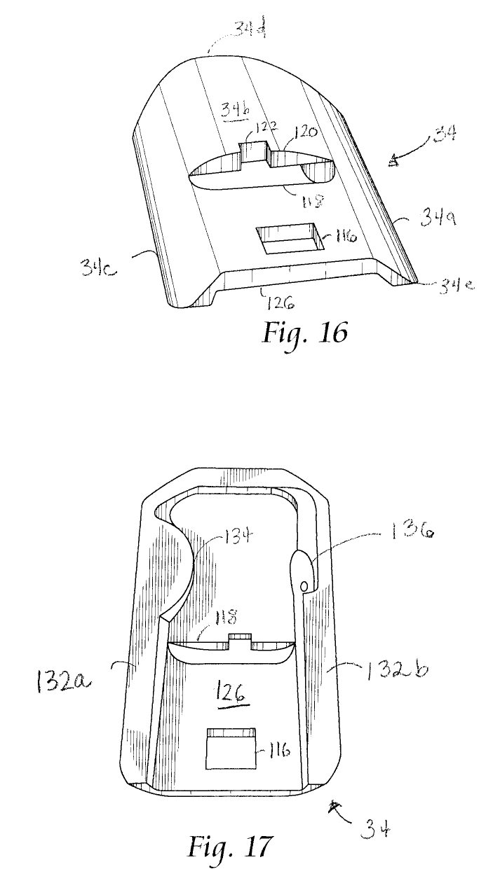

In accordance with the present invention, and as illustrated with respect to a preferred embodiment in FIGS. 1-17, the improved distribution valve 10 optimizes water flow to the fluid outlet ports 28 without substantial leaking. The improved distribution valve 10 substantially lowers stress and wear-related problems on the gear reduction assembly, cam device and housing sections without the use of complicated parts, subassemblies, etc.

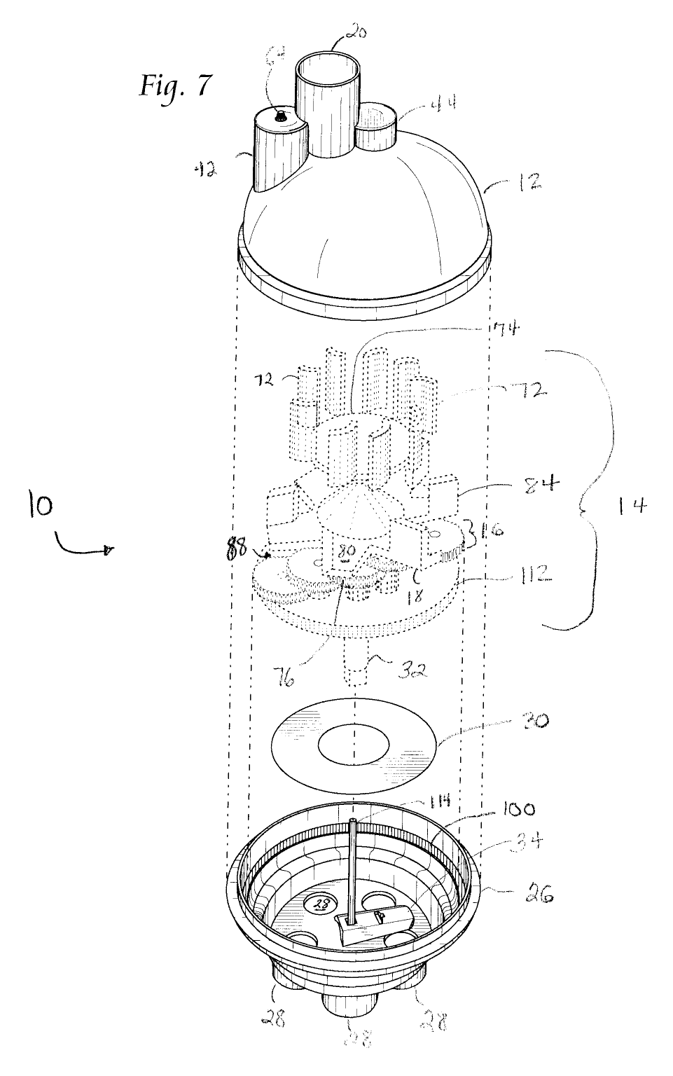

The general structure of the gear reduction assembly 14 is known in the art and shown in dotted lines in FIG. 7. It is to be appreciated that the upper housing section 12 including the speed control assembly 36 and/or the lower housing valve assembly 24 of the present invention may be used in distribution valves having structures other than those shown and described herein.

As shown in FIGS. 1-5, the upper housing section 12 may be substantially dome-shaped and separable from the lower housing section 26 and adapted to be in sealed relationship to the lower housing section 26 to form a “housing.” The housing may be composed of glass-filled polycarbonate or the like. Inside the housing is an open chamber 38. Prior art upper housing sections typically include the fluid inlet port 20 at the peak of the upper dome-shaped section. An inlet tube (not shown) composed of any conventional pipe material such as PVC pipe or the like is received by the fluid inlet port 20.

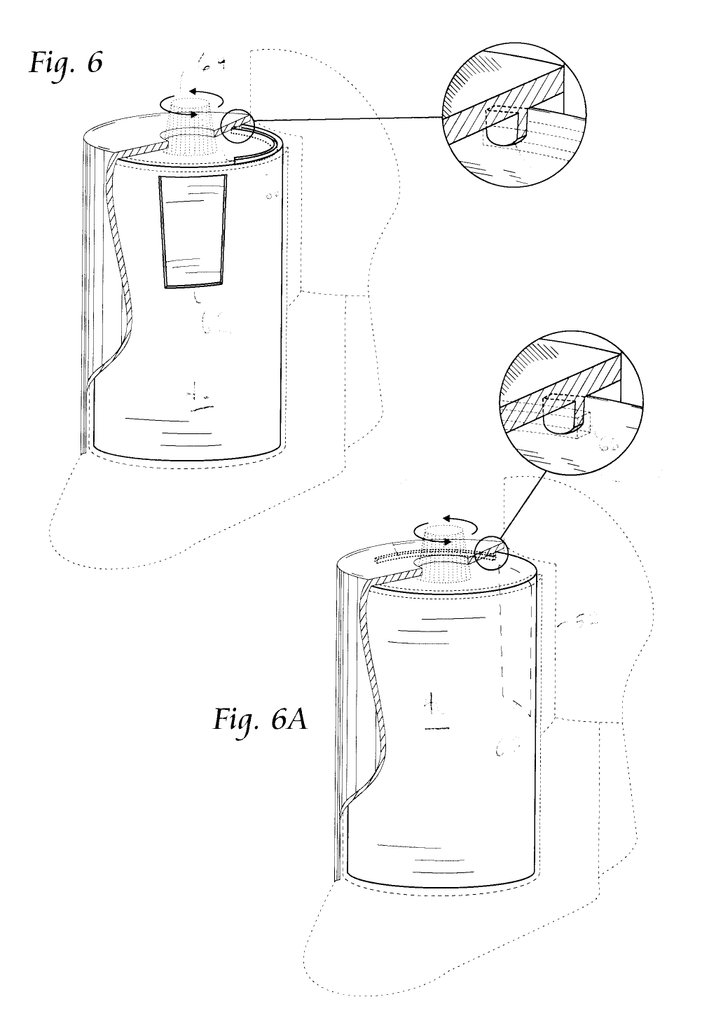

The upper housing section 12 may include the speed control assembly 36 (See FIG. 1-5) of the present invention. The speed control assembly 36 comprises the fluid inlet port 20 at the top of the dome-shaped upper housing section 12. The fluid inlet port 20 may be at an offset position (rather than a central position) between and in fluid communication with a bypass chamber 42 and a diffusion chamber 44. The diffusion chamber 44 may be provided at the peak of the upper housing section 12 with the bypass chamber 42 on the other side of the fluid inlet port 20. A drum 46 may be disposed in the bypass chamber 42. The drum 46 substantially occupies the entire space within the bypass chamber 42 (See FIGS. 6 and 6A).

As shown in FIGS. 1-5, the fluid inlet port 20, bypass chamber 42 and diffusion chamber 44 may be substantially cylindrical. The fluid inlet port 20 has an upwardly open top and a substantially closed bottom. The bypass chamber 42 and diffusion chamber 44 may have closed tops and open bottoms. A tab 48 may extend from the closed top of the bypass chamber 42 into the interior thereof for purposes as hereinafter described. The tab 48 may be substantially semi-spherical (FIGS. 6 and 6A). The fluid inlet port 20 and bypass chamber 42 may be integrally formed and include a shared wall 50 with a first opening 52 in the shared wall defining both an outlet for the fluid outlet port and a bypass chamber inlet (hereinafter “bypass chamber inlet”). The fluid inlet port 20 may be integrally formed with the diffusion chamber 44 and include an opposing shared wall 54 with a second opening 56 in the opposing shared wall defining both another outlet for the fluid inlet port and a diffusion chamber inlet (hereinafter “diffusion chamber inlet”). The open bottoms of the bypass chamber 42 and diffusion chamber 44 respectively provide a bypass chamber outlet 58 and a diffusion chamber outlet 60. The drum 46 may be a substantially hollow cylinder with a top end which is slightly inwardly tapered and a bottom end. The drum 46 may be composed of a pliable material such as vinyl, rubber or the like. A cutout 62 may be defined in the wall of the drum 46. The shape and size of the cutout 62 may correspond with the shape and size of the bypass chamber inlet 52. The drum 46 has a knob 64 that extends through the closed top of the bypass chamber 42 for manually rotating the drum 46 from a fully open position in which the drum cutout 62 is fully aligned with the bypass chamber inlet 52 (FIG. 6A) to permit maximum water flow through the bypass chamber 42 (water flow also occurring through the diffusion chamber 44) to increase the impeller rotation speed to partially open positions where there is partial alignment between the drum cutout 62 and the bypass chamber inlet 52 to slow down the impeller rotation speed, and to a closed position where the bypass chamber inlet 52 is blocked by the drum 46 (FIG. 6) and water flows into just the diffusion chamber 44 from the fluid inlet port 20, in which case impeller rotation is at its slowest speed. The knob 64 may be turned to manually rotate the drum 46 between these incrementally open and closed rotational positions to speed up or slow down rotation of the impeller as hereinafter described. A slot 66 may be defined in the top edge of the drum 46. With the drum cutout 62 being the point of reference, the slot 66 has proximal and distal ends 68 and 70. The distal end may be opposite the drum cutout 62. The tab 48 extending inside the bypass chamber 42 from the top thereof rides in the slot 66 during rotation between the proximal and distal ends 68 and 70 thereof, with the drum 46 being retained against further rotation when the tab 48 engages the respective end of the slot 66. When the drum cutout 62 is fully aligned with the bypass chamber inlet 52, the tab 48 engages the proximal end 68 of the slot 66 (FIG. 6A) and when in a closed position (FIG. 6), the tab 48 is at the distal end 70 of the slot 66. While a rotation stop using a slot in the drum and the tab in the bypass chamber has been described, other arrangements may be used to provide such a rotation stop.

Just beneath the diffusion chamber 44 and attached to the upper interior surface of the upper housing section 12 there may be a plurality of generally cylindrical vertical baffles 72 as known in the art and shown in dotted lines in FIG. 7. Attached to the lower inner edge of each of the vertical baffles 72 is a cone 74. The baffles 72 and cone divert high pressure water from the inlet port 20 that is distributed into the diffusion chamber 44 and the bypass chamber 42 (if the drum 46 is in an open position) and discharged therefrom through their respective outlets. The inlet water first is forced onto the cone 74, so that it is uniformly diverted outward against the vertical baffles 72. The baffles then deflect equal portions of the inlet water against star-shaped protrusions 76 of the impeller 18.

The impeller 18 actually fits very closely underneath the cone 74, and the baffles 72 extend much further downward so that their lower edges almost touch the bottom surface of the star-shaped base plate 80 of the impeller 18. The center portion of the base plate has a centered, conc-shaped peak that fits closely up inside of the underside of the cone 74. A plurality of vertical vanes 84 is disposed on the edges of each of the six protrusions of the impeller 18. A drive gear 86 is attached to the center of the lower surface of the impeller 18. The drive gear engages the two inner gears of the gear reduction assembly 14 as hereinafter described. Each of the vertical impeller vanes has an inner vertical edge which barely clears the outer surfaces of the vertical baffles 72 as the impeller 18 rotates as hereinafter described. The large upper surface areas of the six protrusions of the impeller 18 cooperate with the vertical baffles 72 to greatly confine the direction of flow of high velocity water. This water then directly strikes the inner faces of the vertical impeller vanes, resulting in a high clockwise impeller torque. The vertical baffles 72 are stationary, so as the impeller 18 rotates, the V-shaped gaps 88 between adjacent protrusions of impeller allow the water deflected by the cone 74 and baffles 72 to flow downward into the lower housing section 26 of the chamber after the force of that water has been spent in turning the impeller.

As also known in the art, the gear reduction assembly 14 includes the gear reduction mechanism 16 having the input shaft 22 driven by the impeller 18. The gear assembly 14 may include two symmetrical chains of five gears (some of which are shown in FIG. 7) as is known in the art. The first chain of gears includes a first large gear which is driven by the drive gear. The gear turns small coaxial gear, which in turn drives another large gear. The large gear turns a coaxial small gear, which in turn drives large gear. The teeth of outer gear engage the inner teeth of a stationary planetary gear 100 that preferably is molded integrally with the lower housing section 26. Similarly, and symmetrically with the above-described first chain of gears, the drive gear 86 also drives the second chain of gears described as above with respect to the first chain of gears. The gear reduction mechanism 16 includes the downward-extending output shaft 32 which is connected to the cam device 34 as hereinafter described.

A vertical axle 114 is supported by the bottom of the lower housing section 26 and has an upper end extending through and supported by the upper peak portion of the cone 74. The vertical axle 114 functions as an axis about which the impeller 18, gear support plate 112, and cam device 34 rotate.

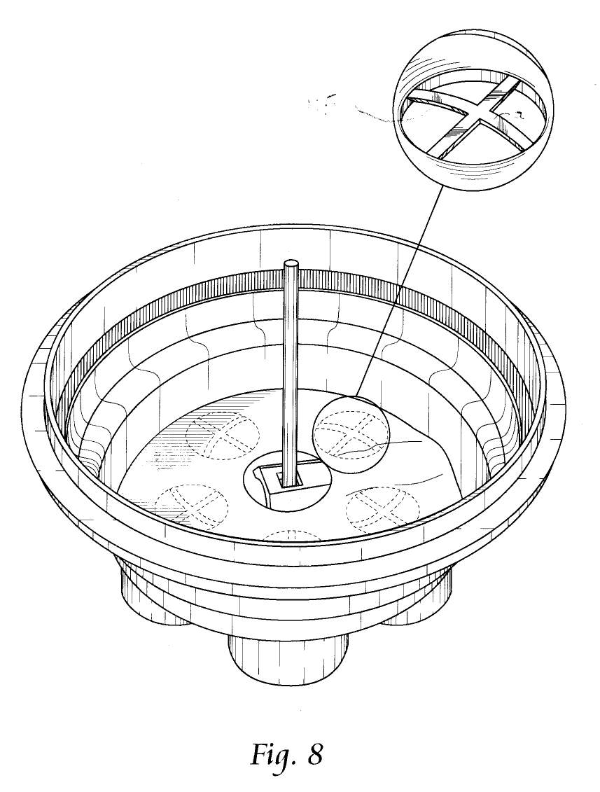

As shown in FIGS. 7 and 8, the lower housing section 26 includes the plurality of fluid outlet ports 28 which are concentrically arranged and disposed in a substantially flat bottom surface (i.e. the floor) of the lower housing section 26. While five outlet ports are typical, it is to be appreciated that the number of outlet ports may be varied. The lower housing section 26 does not include the inclined upper peripheral edge surface and vertical dividers between the outlet ports that are typical in prior art distribution valves. This configuration simplifies and helps minimize manufacturing costs of the improved distribution valve 10 and/or lower housing valve assembly 24.

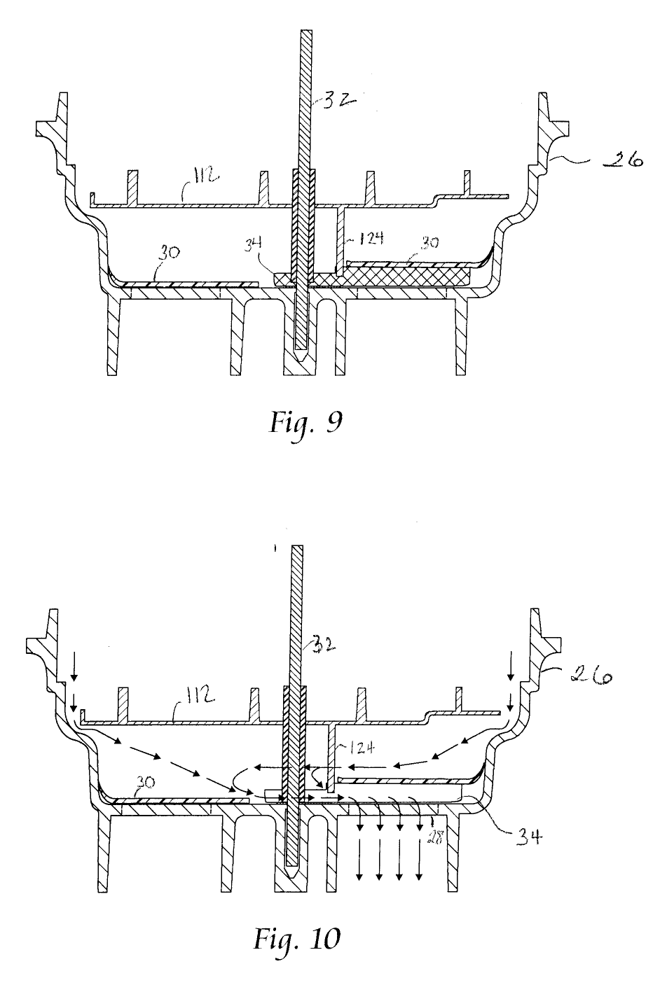

The substantially pliable annular disc 30 may be disposed around the vertical axle 114 against the floor of the lower housing section 26 in a position overlying the plurality of outlet ports and a portion of the cam device 34 as shown in FIG. 8. The annular disc 30 may be composed of molded flexible PVC or the like. A preferred thickness for the annular disc is about 0.058 inches but it is to be appreciated that substantially pliable annular discs of other thicknesses may be used within the confines of the invention as long as the disc remains flexible even in cold water. The annular disc preferably may have a minimum hardness of about 70 Shore, preferably about 85 Shore. Both the thickness and hardness should be such to substantially permit the disc to remain flexible even in cold water. The inner and outer diameters of the annular disc may be sized to amply cover the outlet ports. In a preferred embodiment, the outer diameter may be about 6.038 inches with an inner diameter about 2.50 inches, but other sizes may be used within the confines of the invention. As shown in FIGS. 9 and 10, the peripheral edge of the annular disc 30 may curve slightly upwardly to cup at least a portion of the radius between the floor and wall of the lower housing section 26 to substantially prevent movement of the annular disc out of position particularly with high pressure water turbulence. In a preferred embodiment, the annular disc curves up about ⅛ inches of the radius. In addition support ribs 115 may extend across the fluid outlet ports (See FIG. 8) to support the annular disc 30 and substantially prevent it from being suctioned into the fluid outlet ports 28 with high water pressure. In a preferred form, the support ribs 115 may be substantially trapezoidal with a substantially flat upper surface to provide a smooth support surface. The support rib extending in the cam rotation direction (designated as rib “a” in the encircled region of FIG. 8) may be radial to support rotation of the cam device. The support ribs 115 are preferably integrally molded with the polycarbonate housing although other configurations and materials may be used for the support ribs 115 within the confines of the invention.

While substantial benefit may be derived from the use of flexible PVC for the annular disc, it is to be appreciated that other materials may be used. Suitable materials also include low density polyethylene, urethane. Santoprene® by Monsanto, and vinyl. The annular disc may also be made of natural or synthetic rubbers or the like but these may have to be replaced more often due to deterioration from the chlorine and other chemicals present in pool water. The material used should remain flexible in cold water to permit the cam device 34 to lift and lower sequential portions of the annular disc 30 as hereinafter described.

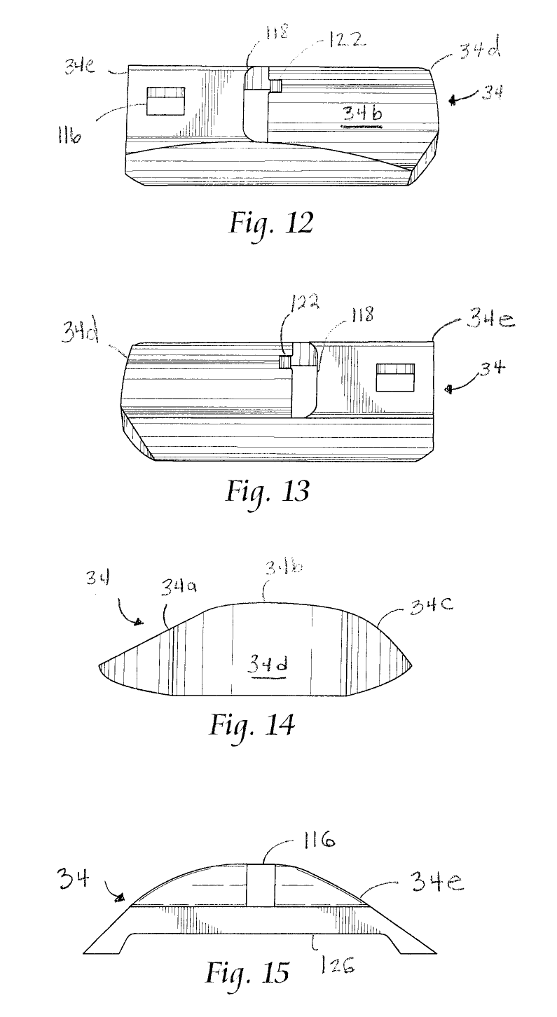

As shown in FIGS. 9-11, attached rigidly to the bottom of the gear support plate 112 and under the annular disc is the cam device 34. The cam device is best shown in FIGS. 12-17. A substantially rectangular opening 116 in a central top horizontal section 34b of the cam device may receive a corresponding square drive from the lower portion of the drive shaft (FIGS. 7-11), which is connected to the output shaft of the gear reduction mechanism 16. A substantially U-shaped opening 118 with a raised edge 120 may also be provided in the cam device. The raised edge 120 provides an extra lift of the annular disc and the substantially U-shaped opening 118 allows a greater volume of water to flow into and through the cam device. The substantially U-shaped opening 118 may be extended to include a semi-spherical pin opening 122 to receive a pin 124 from the gear plate 112 to provide added strength to the annular disc to substantially prevent its twisting or torquing when the cam device rotates as hereinafter described. The cam device 34 comprises a one-piece elongated molded body preferably of ABS plastic material or the like. The material for the cam device 34 should preferably possess surface hardness, be moldable and smooth when molded so that the annular disc will smoothly ride over its upper surface. As shown in FIGS. 12, 13 and 17, the polymeric body has a generally rectangular shape with an inwardly tapering radial front end 34d and a substantially squared off rear end 34e. The front end 34d of the cam device is closed off to water flow and may a slight lip to include a wear bump (not shown) having substantially the same thickness as the shims. The rear end 34e is open to a generally U-shaped channel 126 that extends from the rear end 34e of the cam device 34 and terminates at the front end 34d of the cam device as shown in FIGS. 15 and 17 for purposes as hereinafter described. The cam device has a generally convex upper surface defining camming surfaces including the central top horizontal section 34b between opposed leading rising and trailing falling sides 34a and 34c defining inclined camming surfaces. The leading rising side 34a of the cam device has a shallower incline than the trailing falling side 34c as shown in FIGS. 14 and 15 and both the leading and trailing sides have a radius so that the cam device will rotate smoothly under the annular disc 30 thereby substantially decreasing the stress and tension on the gear reduction assembly, cam device and housing. The cam device has a generally concave bottom surface that defines the generally U-shaped channel 126 as shown in FIGS. 15 and 17. Bottom edges 132a and 132b of the longitudinal leading rising and trailing falling sides of the cam device are of substantially uniform width with a chamfer and the bottom edge 132a of the leading rising side 34a includes an inwardly extending protrusion 134 into the channel 126 and the bottom edge 132b of the trailing falling side 34c of the cam device includes a notch 136 therein for purposes as hereinafter described. While a cam device having a particular configuration has been described it is to be appreciated that substantial benefit may be achieved by a cam device with a different configuration.

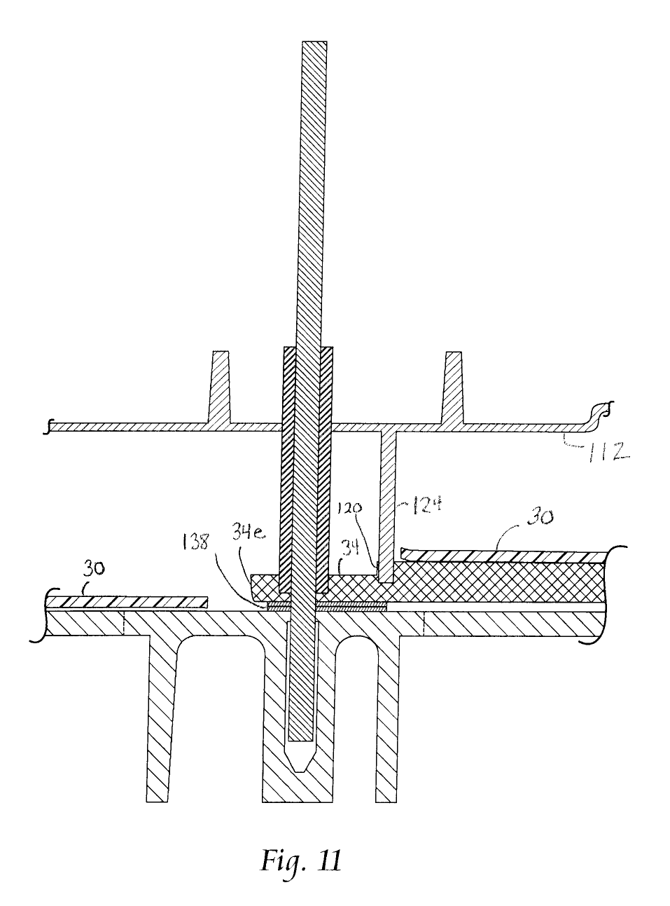

A pair of annular shims 138 (FIG. 11) may be provided at the lower surface of the eccentric rotation point of the cam device to support the cam device and the entire gear assembly and rotary gear support with a minimum amount of friction as the cam device rotates. The shims 138 remain loose on the vertical axle 114. In a preferred embodiment, a pair of stainless steel shims may be used. While the use of a pair of stainless steel shims has been described, substantial benefit may be derived from the use of a different number of shims and composed of a different material.

In accordance with the operation of the distribution valve 10, the cam device rotates under the annular disc 30 eccentrically about the vertical axle 114. The annular disc 30 is pliable over the top of the cam device to substantially eliminate the force on the gear train thus increasing the life of the gear train and the cam device. The gear support plate 112 rotates the cam device. As the cam device rotates, the cam device camming surfaces operate to sequentially lift and lower portions of the annular disc overlying the outlet ports to sequentially open and close the fluid path over each of the outlet ports. The leading rising side 34a of the rotating cam device is the first point of the cam device to unseat or lift a portion of the annular disc. As the cam device rotates, the lifted portion of the annular disc rides up the inclined leading rising side 34a of the so as to open the fluid path through the corresponding fluid outlet port, then holds the corresponding fluid path through the fluid outlet port open as the annular disc 30 rides along the central top horizontal section 34b, and lowers the annular disc to close the fluid path through the fluid outlet port as the annular disc 30 rides down the trailing falling side 34c of the cam device. As the leading rising side 34a of the cam device has a shallower incline than the trailing falling side 34c as shown in FIGS. 14 and 15, the sealing or closing of the fluid path through the previous outlet port is faster than the opening of the next outlet port. For a small portion of the rotation of the cam device, two outlet ports may be partially open. As the closing of one outlet port is being completed (the “previous outlet port”), the opening of the next outlet port (“next outlet port”) is beginning to occur, so there is never a time when all of the outlet ports are completely closed. The fact that the next portion of the annular disc 30 is partially unseated or lifted before the previous portion is lowered prevents water pressure from building up to too high a level inside the chamber. As the cam device further rotates, the inwardly extending protrusion 134 clears the next outlet port and the notch 136 clears the previous outlet port causing water flow through the previous outlet port to shut down substantially instantaneously with a surge of water through the next outlet port.

The pool return water from the high pressure side of the pool pump is fed into the vertical inlet pipe connected to the top of the upper dome-shaped section of the distribution valve 10. The water then flows out to the lower housing section 26 through the diffusion chamber outlet 60 and the bypass cylinder outlet 58 unless the bypass chamber inlet 52 is blocked by the drum 46 in which case it flows through only the diffusion cylinder. As shown in FIG. 10, the water flows under the annular disc 30 and into the rear end 34e of the cam device and the substantially U-shaped opening 118, through the cam device channel 126, and out through the open fluid outlet ports 28 to riser pipes (not shown) that supply water to the pool cleaning heads. The high water pressure in the interior chamber 28 of the distribution valve 10 produces downward force on the annular disc, thus improving its sealing action against closed and partially closed outlet ports. The substantially flat floor of the lower housing section 26 also helps such sealing action.

From the foregoing, it is to be appreciated that the improved distribution valve 10 optimizes water flow through the cam device and out the fluid outlet ports 28 while minimizing stress and tension on the gear assembly and while substantially eliminating leaking without the use of complicated valve assemblies. In addition, if using the upper housing section 12 with the speed control assembly 36, the speed of the impeller 18 may be substantially controlled.

Although a particular embodiment of the invention has been described in detail for purposes of illustration, various modifications may be made without departing from the spirit and scope of the invention. Accordingly, the invention is not to be limited, except as by the appended claims.

I claim:

1. A distribution valve having a fluid inlet port and a plurality of fluid outlet ports, the distribution valve comprising:
a housing including a lower housing section and a removable upper housing section adapted for sealing engagement with the lower housing section;
a gear reduction assembly inside the housing including a gear reduction mechanism and an impeller located in fluid communication with the fluid inlet port and connected to a rotary input shaft to drive the gear reduction mechanism;
a substantially pliable annular disc in the lower housing section which overlies the plurality of fluid outlet ports and disposed on a rotary output shaft of the gear reduction mechanism; and
a cam device engaging the rotary output shaft and rotating under the substantially pliable annular disc in response to rotation of the impeller to lift and lower portions of the substantially pliable annular disc to sequentially open and close fluid paths through the plurality of fluid outlet ports.

2. The distribution valve of claim 1 wherein the lower housing section has a substantially flat bottom surface with the plurality of fluid outlet ports disposed therein.

3. The distribution valve of claim 1, further comprising a speed control assembly wherein the fluid inlet port is disposed at the top of the upper housing section in fluid communication with a bypass chamber having a rotatable drum therein and a diffusion chamber, the drum rotatable to adjust the flow of water through the bypass chamber to control the impeller rotational speed.

4. The distribution valve of claim 3, wherein the drum is rotatable to fully or partially align a cutout therein with a bypass chamber inlet to permit water flow through the bypass chamber and rotatable to block water flow into the bypass chamber.

5. The distribution valve of claim 4 wherein the drum has a slot with proximal and distal ends and the bypass chamber has a protrusion with the protrusion engaging the slot during rotation, the drum being retained against further rotation when the protrusion engages one of the proximal and distal ends of the slot.

6. The distribution valve of claim 3 wherein the drum has a knob for manually rotating the drum to adjust the flow of water.

7. The distribution valve of claim 1 wherein the cam device has camming surfaces that include a level camming surface between a leading rising inclined camming surface and a trailing falling inclined camming surface the leading rising inclined camming surface having a shallower slope than the trailing falling inclined camming surface.

8. The distribution valve of claim 1 herein the cam device operates to begin lifting the next portion of the substantially pliable annular disc before completely lowering a previously lifted portion.

9. The distribution valve of claim 1 wherein a channel is defined in the bottom of the cam device between a closed front end and an open rear end which permits water flow into the open rear end and through the channel to the open fluid paths.

10. The distribution valve of claim 9 wherein the cam device further includes a substantially U-shaped opening with a raised edge to permit additional water flow therethrough to the open fluid paths.

11. The distribution valve of claim 1 wherein the bottom of the cam device includes an inwardly extending protrusion and a corresponding notch causing water flow through a previous fluid outlet port to shut down substantially simultaneously with a surge of water through a next fluid outlet port.

12. A lower housing valve assembly adapted for sealable engagement with an upper housing section of a distribution valve having a gear reduction assembly and a fluid inlet port, the gear reduction assembly including a gear reduction mechanism and an impeller located in fluid communication with the fluid inlet port and connected to a rotary input shaft to drive the gear reduction mechanism, the lower housing valve assembly comprising:
a lower housing section having a substantially flat bottom surface and a plurality of fluid outlet ports disposed therein with a plurality of support ribs extending across the plurality of fluid outlet ports;
a substantially pliable annular disc which overlies the plurality of fluid outlet ports and adapted to be disposed on a rotary output shaft of the gear reduction mechanism;
a cam device adapted to engage the rotary output shaft to rotate under the substantially pliable annular disc in response to rotation of the impeller to sequentially lift and lower portions of the annular disc to sequentially open and close fluid paths through the plurality of fluid outlet ports.

13. The distribution valve of claim 12 wherein the cam device has camming surfaces that include a level camming surface between a leading rising inclined camming surface and a trailing falling inclined camming surface, the leading rising inclined camming surface having a shallower slope than the trailing falling inclined camming surface.

14. The distribution valve of claim 12 wherein the cam device operates to begin lifting the next portion of the substantially pliable annular disc before completely lowering a previously lifted portion.

15. The distribution valve of claim 12 wherein a channel is defined in the bottom of the cam device between a closed front end and an open rear end which permits water flow into the open rear end and through the channel to the open fluid paths.

16. The distribution valve of claim 15 wherein the cam device further includes a substantially U-shaped opening with a raised edge to permit additional water flow therethrough to the open fluid paths.

17. The distribution valve of claim 12 wherein the bottom of the cam device includes an inwardly extending protrusion and a corresponding notch causing water flow through a previous fluid outlet port to shut down substantially simultaneously with a surge of water through a next fluid outlet port.

18. A speed control assembly for a distribution valve having a housing with a gear reduction assembly therein, a fluid inlet port, and a plurality of fluid outlet ports, the gear reduction assembly including a gear reduction mechanism and an impeller located in fluid communication with the fluid inlet port and connected to a rotary input shaft to drive the gear reduction mechanism comprising:
a bypass chamber in fluid communication with the fluid inlet port through a bypass chamber inlet;
a rotatable drum within the bypass chamber substantially filling the bypass chamber, the rotatable drum having a cutout in the wall thereof;
a diffusion chamber in fluid communication with the fluid inlet port through a diffusion chamber inlet; and
wherein the drum is rotatable between open positions in which the drum cutout fully or partially aligns with the bypass chamber inlet to permit fluid flow therethrough to the plurality of fluid outlet ports and a closed position in which the drum blocks the bypass chamber inlet to prevent fluid flow therethrough.

19. The speed control assembly of claim 18 wherein the drum has a knob for manually rotating the drum to adjust the flow of water through the bypass chamber inlet.

20. The method of distributing water pumped from a swimming pool pump to a fluid inlet port of a distribution valve through a plurality of fluid outlet ports in the bottom of the distribution valve to cleaning heads disposed in a swimming pool, the method comprising the steps of:
providing a substantially pliable annular disc over the plurality of fluid outlet ports;
rotating a cam device under the substantially pliable annular disc in response to a gear reduction mechanism in the distribution valve the cam device rotated by an impeller in fluid communication with pressurized water in the fluid inlet port, wherein the rotating cam device sequentially lifts and lowers portions of the substantially pliable annular disc to sequentially open and close fluid paths through the plurality of fluid outlet ports.

21. The method of claim 18 wherein a protrusion from the bottom edge of the leading inclined side of the cam device and an opposed notch from the bottom edge of the trailing side of the cam device stop water flow through a previous fluid outlet port substantially simultaneously with water ejection through the next fluid outlet port.
